(19) United States
(12) Patent Application Publication
(10) Pub. No.: US 2002/0078382 A1
(43) Pub. Date: Jun. 20, 2002

(54) Scalable system for monitoring network system and components and methodology therefore

(76) Inventors: Ali Sheikh, Dallas, TX (US); Jason Jordan, Dallas, TX (US); Brian Tabone, Austin, TX (US)

Correspondence Address: William N. Hulsey III, Hughes & Luce, L.L.P., 1717 Main Street, Suite 2800, Dallas, TX, 75201, US

(21) Appl. No.: 09/858,085

(22) Filed: May 15, 2001

Related U.S. Application Data
(60) Provisional application No. 60/253,912, filed on Nov. 29, 2000.

(51) Int. Cl. G06F 11/30

(52) U.S. Cl. 713/201; 709/224

(57) ABSTRACT

The present invention is a security software methodology and system that takes an internal approach to mitigating security risks from authorized and unauthorized users. The security software system uses the methodology of monitoring, in great detail, any configuration changes made to information systems within a network. These systems and applications include web servers, firewalls, proxy servers, log servers, intrusion detection software systems, routers and any other device or application which can be considered a part of the enterprise information system infrastructure.

This application is based on Provisional Application No. 60/253,912, filed Nov. 29, 2000. This application includes subject matter protected by copyright.

### BACKGROUND OF THE INVENTION

1. Technical Field

The present invention relates to computer software security systems, and more specifically, to the monitoring of computer network systems for security purposes.

2. Description of the Related Art

Information security is experiencing a growth in importance since commercialization of the Internet. Modest security tools were mostly available for free on “ftp sites” before this commercialization and these tools were often only used sparingly by systems administrators at universities and government agencies. The security tools were generally not effective for providing much more than password protection and most IT managers did not have a budget to provide security measures. Security was an esoteric subject discussed in academic circles. In those days, password protection and anti-virus tools were usually all the security an organization thought it needed. Later companies began to develop “firewall” products to protect the company against attacks from intruders outside of the company's main network.

As the Internet commercialized, new companies emerged to capitalize on the potential to market products to a vast audience through what we now define as “eCommerce”. For example, early on consumers reluctance to give credit card information or other personal information over the Internet created an opportunity to mitigate the risk and alleviate consumer concerns. In the late 1990's “B2B” or business-to-business eCommerce began to develop. This marketing concept involved large quantities of transactions over the Internet. Disruption of these transactions could be costly, and even disastrous, in terms of lost business and embarrassment. Additionally, in late 1999 and early 2000, denial of service attacks cost various companies revenues estimated to be millions of dollars. Companies began to realize how quickly they could lose their credibility with consumers and revenue. Additionally, government agencies enacted tougher laws against “cyber crime”. The confluence of several embarrassing and well publicized security failures and a still maturing eCommerce environment soon solidified the overwhelming importance for information security.

Presently, the concept of “security” can be divided into numerous distinct areas. There are perimeter security systems such as firewalls, which filter traffic allowed into and out of a network. Intrusion Detection Systems are responsible for inspecting network traffic and identifying any anomalies or suspicious activity. Content filtering tools are responsible for guarding against employee abuse of Internet services such as viewing pornographic or other questionable web sites on company time and with company resources. Anti-virus tools guard against viruses from corrupting data. Finally, encryption tools are used to encrypt data such that only certain individuals may be able to decrypt and view it. Almost all security tools currently available in the market today fall into one of these categories above. However, this does not mean that security threats are limited to just these specific areas.

While most of the public knowledge suggests that attacks from outside “hackers” are the largest threat to a companies network, a survey from various security groups suggest that internal attacks, i.e. those from a company's own employees are the greatest danger. According to one, for example, the average insider attack costs the target enterprise over $1 million, compared with $60,000 for the average external attack by individuals and institutions outside of a company. Additionally, private networks are often the victim of “operator error” or caused by employee's mistakes in operating the network. This can be as wide ranging as an employee who mistakenly changes the configuration of a server, to accidentally modifying important routines within the network. Additionally, with the concern over privacy and personal information, certain sectors of industry are being required by federal and state governments to ensure that their networks are safe from attacks both internal and external.

Presently, a problem exists in the security software field because companies need to have security software that has the ability to monitor various aspects of the network and allow for forensic analysis when a breach or problem does occur. Additionally, because of changing government regulations, companies are in need of security systems that can provide an auditable trail that governmental regulations and verify that company baselines are followed. While the current security devices might protect against certain attacks, they do not monitor for any changes, including those that are simple or complex, to operating systems, that do not necessarily rise to the level of an attack, yet place the network in jeopardy or fall outside of the companies standard guidelines for its system. Finally, as a company scales its network or changes its monitoring requirements, the companies are searching for a methodology to monitor their networks that require minimal resistance and maximum flexibility to scalability.

### BRIEF SUMMARY OF THE INVENTION

The present invention is preferably implemented as a computer program operative through a network system comprising a transport layer connectable between a central server and one or more second servers, wherein the transport layer provides for aggregating, storing, encrypting, and transport results compiled from subroutines located on the one or more second servers. Although the invention is described in the context of a single network, one of ordinary skill in the art will appreciate that the described functionality may be implemented across multiple networks of different structure.

The present invention is a security software methodology and system that takes an internal approach to mitigating security risks from authorized and unauthorized users. The security software system uses the methodology of monitoring, in great detail, any configuration changes made to information systems and their applications within a network. These systems and applications include web servers, firewalls, proxy servers, log servers, intrusion detection software systems, routers and any other device or application which can be considered a part of the enterprise information system infrastructure.

The present invention accomplishes its tasks by monitoring and archiving in a central database changes made to systems. The software can be configured to alert by email, pager or any other method, including communication or wireless device when certain configuration changes have occurred. ISAT can serve as an auditing tool that monitors systems to make sure current security policies are being adhered to. This auditing capability helps to achieve compliance.

The foregoing has outlined some of the more pertinent objects and features of the present invention. These objects should be construed to be merely illustrative of some of the more prominent features and applications of the invention. Many other beneficial results can be attained by applying the disclosed invention in a different manner or modifying the invention as will be described. Accordingly, other objects and a fuller understanding of the invention may be had by referring to the following Detailed Description of an Exemplary Embodiment.

### BRIEF DESCRIPTION OF THE DRAWINGS

For a more complete understanding of the present invention and the advantages thereof, reference should be made to the following Detailed Description taken in connection with the accompanying drawings in which:

FIG. 1 is a schematic diagram of a typical network of data processing systems;

FIG. 1A is a distributive network with the present invention implemented thereupon;

FIG. 2 is an agent transport and its associated parts in block diagram format;

FIG. 3 is the master transport located on the central server in block diagram format;

FIG. 4 is a typical corporate demilitarized zone within the corporate network;

FIG. 5 is an overview of the transport layer during startup mode and continuous operations;

FIG. 6 is a flow charts showing the method by which the transport receives the initial sensor information and the method by which the transport interacts with that sensor;

FIG. 7 is a flow chart that displays the methodology for the master transport to execute the eval programs in the central server;

FIG. 8 is a flow chart displaying the methodology that the master transport requests data from the agent transport;

FIG. 9 is a flow chart that displays the methodology for the configuring the agent transport;

FIG. 10 is a flow chart which displays the methodology for code signature verification;

FIG. 11 is a table that shows the various components that may be monitored by the present invention.

### DETAILED DESCRIPTION OF AN EXEMPLARY EMBODIMENT

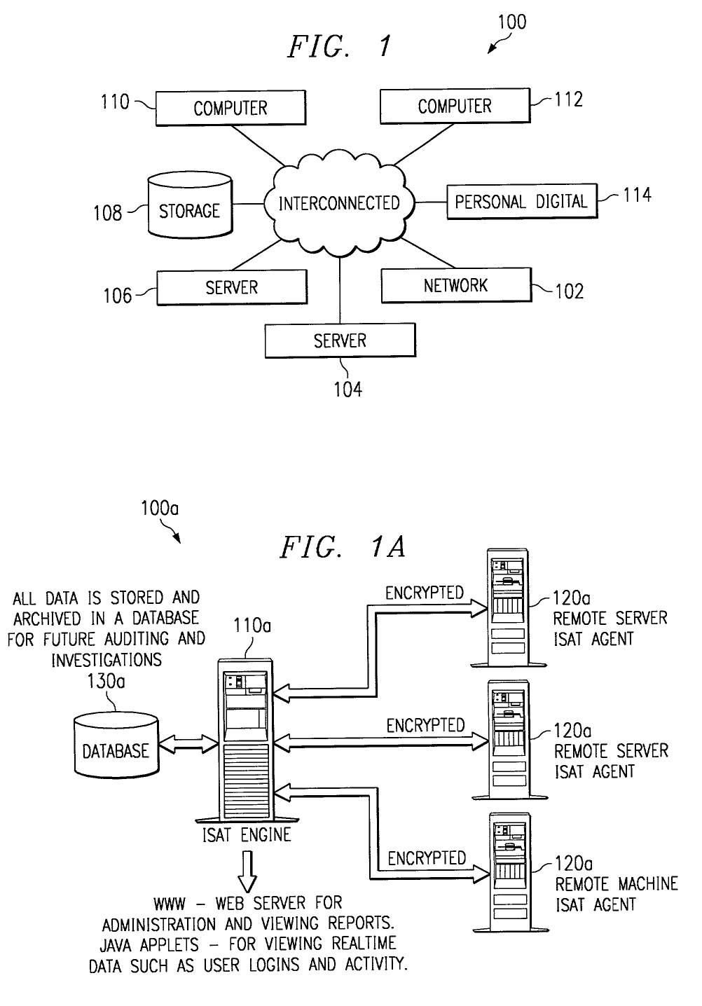

A representative system in which the present invention is implemented is described as follows. FIG. 1 is a schematic diagram of a typical network of data processing systems. Any of the data processing systems of FIG. 1 may implement the present invention. A distributed data processing system 100 contains a network 102. The network 102 provides communications link between all the various devices and computers communicatively connected within the distributed processing system 100. The network 102 may include permanent connections, such as wire or fiber optic cables, or other types of connections such as wireless, satellite, or infrared network technology.

The network 102 may operate under a number of different operating schemes. Communications may flow between the associated components of the distributed processing system 100 under various protocols, including TCP/IP. The network 102 may also be indicative of several interconnected networks, such as the Internet.

The network 102 connects a server 104 and a server 106. Additionally, a storage unit 108 is also communicatively connected to the network 102, thus allowing the servers 104 and 106 to communicate with and store data to and from the storage unit 108. Other typical clients on the network 102 may be stand-alone computers 110 and 112. Additional computing components communicatively connected to the network 10 may include a personal digital assistant 114.

It should also be noted that the distributed data processing system may also include numerous different types of networks. Any one of, or any combination of, for example, an intranet, a local area network (LAN), a wide area network (WAN), or an aggregation of units may be communicatively connected to each other in a fashion.

If using the network in a fashion secured from outside networks, the network may be local to the individual clients. Or such secure network may be implemented upon a public network using various security protocols, thus creating a virtual secure network (VSN) molded from the public network infrastructure. Also, the present invention may be implemented on a variety of hardware and software platforms, as described above.

FIG. 1A is a distributive network with the present invention implemented thereupon. In FIG. 1A the present invention is implemented in computer network 100a. Network 100a comprises of a master transport located on a central server 110a, which is dedicated to running the transport layer and storing results. The central server 110a provides for the polling of one or more agent transports, which are located throughout network 100a on the agent transport's associated host servers 120a. Information which is transported between the central server 100 and agent transport's host servers 120a is bi-directional. All data being transmitted from the agent transport to the master transport may be encrypted for additional security. Reports received from the agent transport are evaluated on the central server 110a and all auditable or storable results are stored on a database 130a located within the central server. One aspect of the invention is that it allows an administrator to query the central database and view at any particular period in time the historical configuration, configuration changes, or any other monitored aspect of network 100a. The invention can monitor configurations of multiple software applications located through network 100a on various host servers 120a and allows the network or enterprise to consist of as many agent servers and applications, including those required by the network administrator, which may be locally or geographically distributed across the globe. The present invention also provides a Web/HTML driven user interface, which allows the user to view reports, historical or otherwise, create customized reports, make configuration changes, view and set alerts and other functionalities associated with the present invention via a remote location. The present invention is platform independent hence the Web interface can be viewed using any web browser.

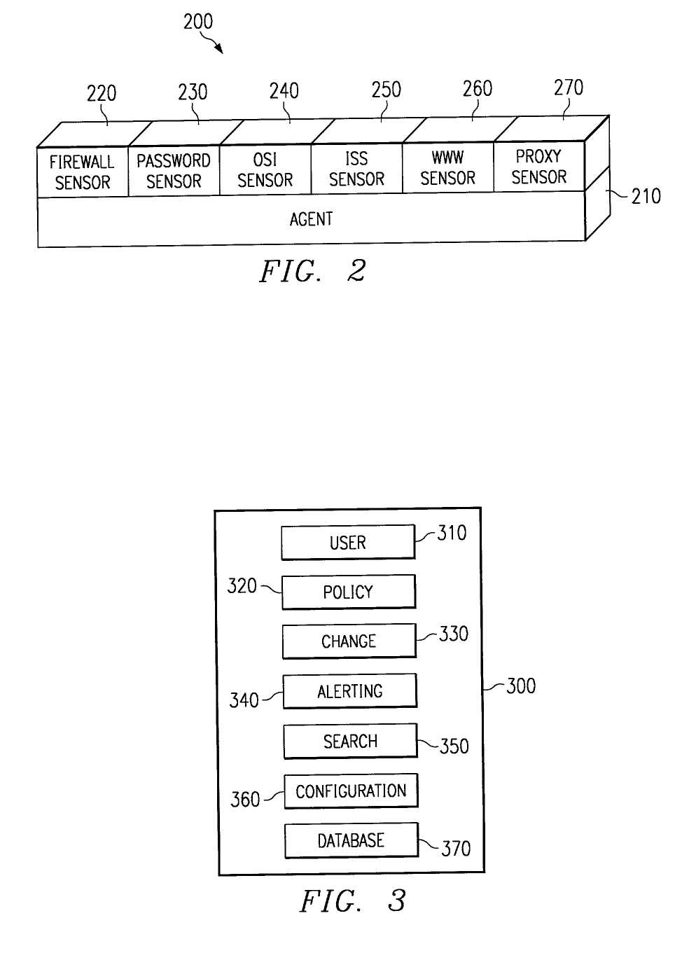

FIG. 2 is an agent transport and its associated parts in block diagram format. The Agent transport is a small software package, which is installed on each monitored hosted server. The agent transport implements sensor programs sequentially on the host server and actually performs the desired monitoring routines. The agent transport is designed to selectively execute only those sensors which have been selectively activated by the user in order to monitor specific aspects of the host server. The administrator selects the sensors during the configuration of the agent transport's programs described herein below. Dividing the agent transport into sensors is a unique aspect of the present invention and allows for easy addition of new features and monitoring capabilities as the Network 100 grows or as new programs are added to the Network.

The task of the agent transport is to monitor the sensors located on its host server, gather information generated by those sensors, encrypt that information, store it on its host server local disk until the information is requested by the master transport, and transport the information to the master transport when requested. In FIG. 2 agent transport 200 is comprised of agent transport layer 210 and various sensors. While the sensors located on any particular host server may vary and are determined for each host by the administrator, the sensors in the FIG. 2 example are a firewall sensor 220, a password sensor 230, a OSI sensor 240, an ISS sensor 250, a worldwide web sensor 260, and a proxy server sensor 270. The execution of each sensor is controlled by the agent transport, and each sensor passes its results to non-volatile memory where the agent transport collects and compiles the results. Because of this design, the present invention makes it difficult for a user or a hacker to change a configuration on a host server being monitored without detection by the sensors, because the sensors are constantly monitoring its responsible sub-systems for changes or intrusions. If a change occurs, in addition to capturing the actual change, the change is time stamped for forensics analysis. A central trusted and accurate time source is used to synchronize time and date information on all monitored systems across the enterprise.

FIG. 3 is the master transport located on the central server in block diagram format. The master transport comprises of evaluation executable routines called “evals” which relate to the master transport layer, much the same way that the sensors relate to the agent transport. Any result received from agent transport is processed by the evals. Additionally, each sensor has a corresponding eval routine located on the master transport. In FIG. 3, master transport 300 comprises of a user program 310, a policy sub-routine 320, a change eval 330, an alerting program 340, a search routine 350, a configuration eval 360, and a database 370.

Both sensor and eval are executable blocks of code. The sensor monitors the host server for various attributes on the host server, while the evals parse the results sent by the agent transport to the master transport, and loads it into the central server's database. The sensor is pushed by the master transport to target host servers for monitoring. The sensor gets executed at specific intervals as dictated by its associated agent transport located on its host server, and returns results from its execution as new data is found. The agent transport will then package and encrypt the results from each sensor on the host machine for transport back to the master server. The eval remains on the central server, and gets called by the master transport when new results are transported from an agent transport to the central server. The master transport reads information on the consolidated result package and determines which eval is needed to evaluate each parsed result, based on the name of the data file that is received. A systematic naming convention is used to allow the master transport to identify which sensor returned the result. This information does not need to be host server specific. The appropriate eval is then executed, and the result name is passed to the eval in a global variable. The eval must then read this data file and parse the actual result and load it into the database.

A separate eval exists for each corresponding sensor located on an agent transport. For example, if the incoming result is firewall policy change then the firewall eval processes it and the change if is web server result then the web server eval will process it. The master transport recognizes the type of result received and passes it to the appropriate eval program. This one-to-one or modular approach to the design of sensors and evals enables quick development and integration of the present invention with any new product. Features for the present invention can be added easily with this design without the need to rewrite either the master transport or agent transport components. Users do not need to uninstall or install the master transport every time an upgrade or new version is released or rewrite blocks of controlling code.

The master transport pushes new sensors to the monitored systems as they are added. A network administrator only needs to install upgrades on the central server and the software ensures upgrading to all monitored systems, automatically. This systemology reduces administration costs and total cost of ownership.

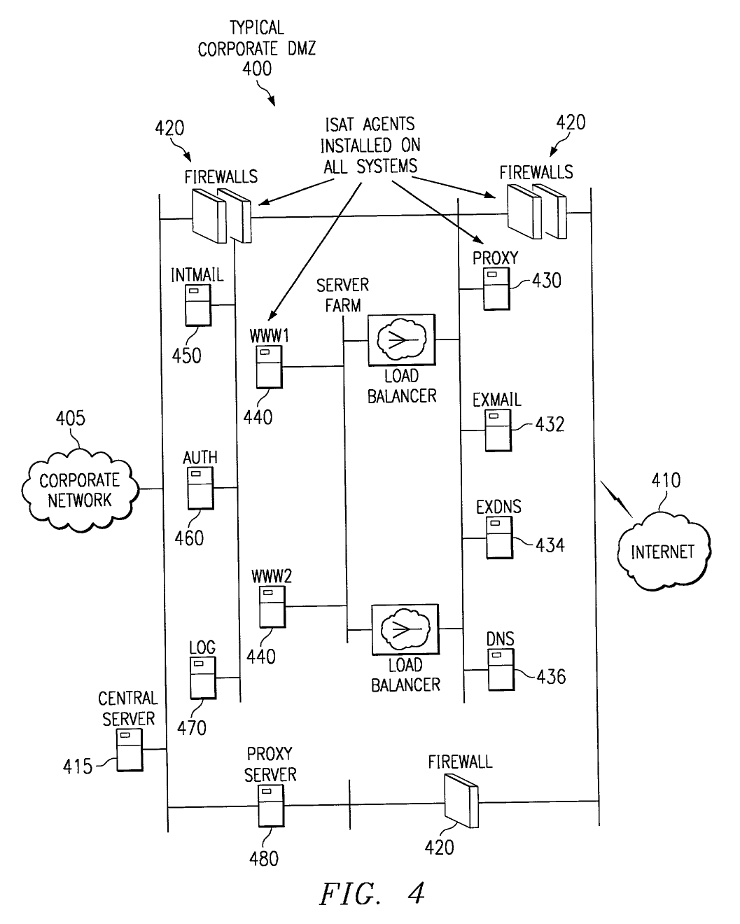

The present invention is typically deployed on a corporate DMZ or demilitarized zone. A DMZ is a separate network which serves as a buffer between a corporate private network and the public internet. FIG. 4 is a typical corporate DMZ 400 within the corporate network 405, which is communicatively connected through DMZ 400 to the Internet 410. Corporate DMZ 400 comprises of a central server 415, wherein the master transport of the present invention is deployed, various firewall servers, 420, external proxy server, 430, external e-mail server 432, external domain name server, 434, internal domain name server 436. Also included in the corporate DMZ 400 are worldwide web firewall servers 440 and internal e-mail server 450, an authorization server 460, a log server 470, and a proxy server 480. In one embodiment of the present invention, every information system located within a DMZ and every system managed by external business partners requires agent transports to be installed on them, and agent transports can be located on any server located within the typical corporate DMZ. The central server 415 is dedicated to host the master transport. Note that the agent transports'focus on the internal security of an enterprise, hence they should be installed on all systems accessed or maintained by the organization. Any changes made by individual(s) to a system will be monitored and recorded.

The master transport initiates all contact with its agent transports. The agent transport provide instructions to the sensors, store information from the sensors on the local disk and finally encrypt and transport the collected results to the master transport when requested. The task of the master transport is to poll each agent transport in turn, receive the results, decrypt that information, evaluate it, store it on its central server and report the information upon request by a user. If at some point during the communication between the agent transport and the master transport, a network failure occurs, the agent transport queues the collected results on its host server until network communication with the master transport is restored. When communication is restored, the results are transported to the master transport and the queue on the agent transport is emptied. Thus, the present invention insures against data loss. However, the master transport logs this temporary breakdown as an incident needing further investigation.

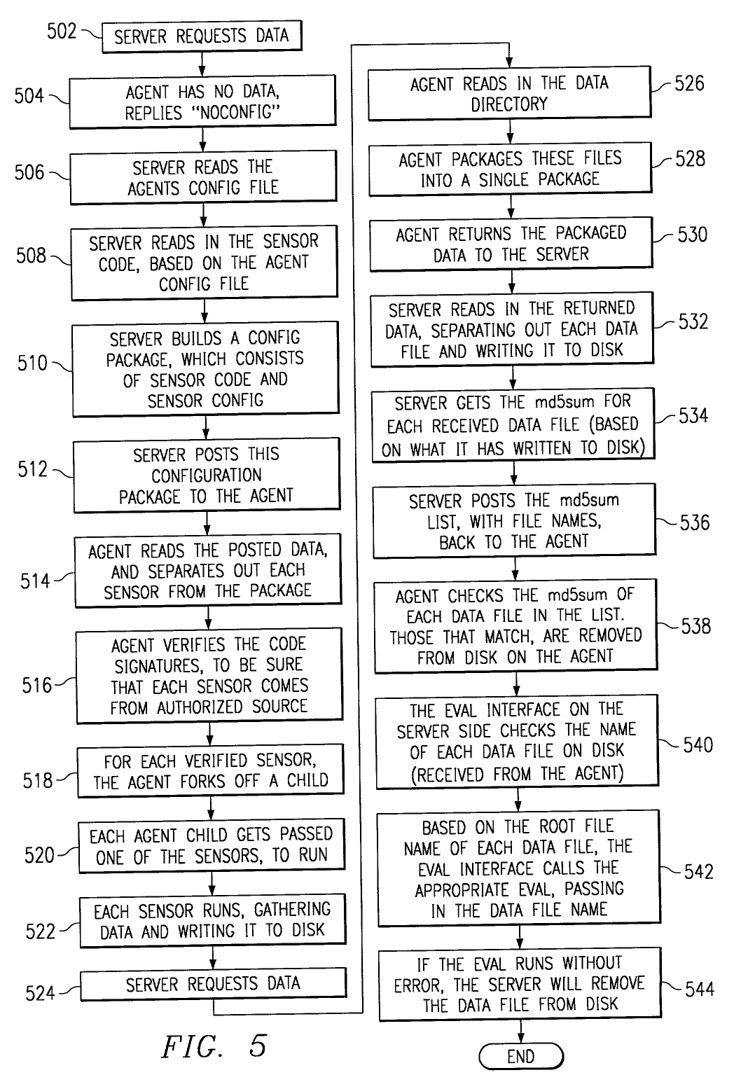

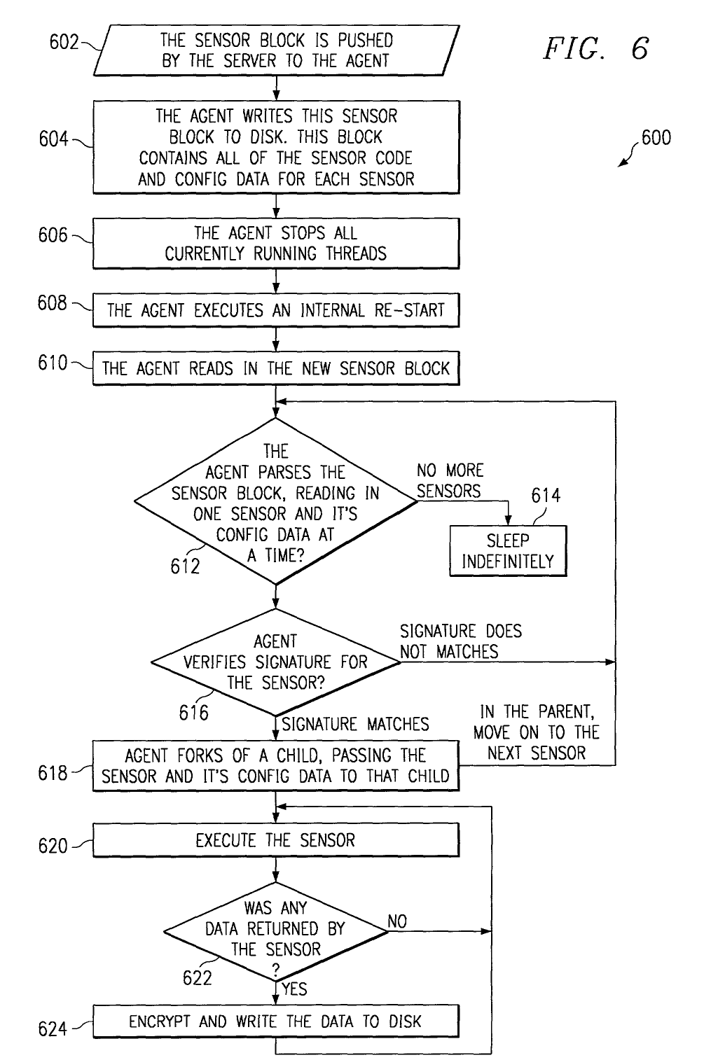

FIG. 5 is an overview of the transport layer during startup mode and continuous operations. The master transport transports information bi-directionally with the agent transports, as appropriate. The transport portion of the present invention is designed to be fully abstracted from the sensors and eval programs. The transport has no knowledge of the specific tasks or interworkings of the sensors or evals. As described above, the sensors and evals are actually executable segments of code. The transport interacts with sensors and evals as follows: The transport controls, through the agent transport and the master transport, when a sensor program or an eval program executes. The master transport provides data file names to eval. The eval subsequently opens the data file, reads in and parses the specific data to the central server. The agent transport packages and encrypts any results returned by a sensor located on that agent server's host server. In this way, security is handled by the transport layer through an agent master transport, in a consistent fashion. Logging facilities are provided to sensors and evals through their respective transports. A status API is provided to the sensors so that they may keep track of their last known state, and only return a result when that state has changed. These status files are encrypted by the agent transport to prevent tampering.

In FIG. 5, initiating connections occurs by the master transport. This is a distinctive feature of the present invention. This methodology is done to ensure security of the servers and other systems on the network. This is also a TCP (Transport Control Protocol) based connection using a high port. The master transport can connect to the agent transports in parallel as well as serially. In parallel mode the master transport can connect to multiple agent transports at a time and transfer or receive data accordingly. This feature works well in large environments that may consist of hundreds of servers being monitored. Using the parallel mode communication, the master transport can poll a large number of agent transports quickly. In serial mode communication the master transport connects to a single agent at a time. This mode is cheaper to implement due to the fact that it requires less computing power. Serial mode is optimal in small environments of 100 or fewer monitored systems. All communication between the agent transport and the master transport is encrypted to further ensures the security of the results and is important because the data is critical configuration information of every server being monitored.

In FIG. 5, the master transport requests data in step 502 from a newly loaded agent transport. When an agent transport is first started, it reads a local configuration file which, in an exemplary embodiment, is called internal.status. In an exemplary embodiment, if this file does not exist, the agent goes into standby mode. When the master transport contacts the agent transport, it returns the value “NOCONFIG” in Step 504. After receiving the NoConfig in step 504, the master transport proceeds to read the agent transport's configuration file that is partially loaded on the central server to determine the necessary configuration for the agent transport. The master transport reads in the sensor code located on the central server for that agent transport, based on the agent transport's configuration file in step 508.

Upon reading the sensor code, the master transport in step 510, builds a configuration package for the agent transport, consisting of a sensor authorization code and each corresponding sensor configuration information. Each host has it's own unique configuration stored on the central server. The unique configuration dictates what sensors will be pushed to the agent transports, hence what parameters of that particular host will be monitored. The master transport next posts or transports this configuration package to the agent transport in step 512, for proper configuration of the agent transport. When the agent transport receives this post, in an exemplary embodiment, it writes the package out to the file called “internal.status”. This is an encrypted file, which is written using a encryption key returned by system. An encryption key is a random data set used by the encryption algorithm to encrypt data. The encryption key is then used by a different component of the system to decrypt the data in a symmetrical encryption/decryption algorithm. The agent transport reads the configuration package posted to it by the master transport, and parses or separates out each sensor from the configuration package in step 514.

Once the sensor data is separated, the agent transport then verifies the authorization code signatures for each sensor to be sure that each sensor is an authorized sensor and is received from an authorized source. This occurs in step 516. As the agent transport verifies each sensor, the agent transport forks off an agent transport child in step 518, wherein each child gets passed one of the sensors to run on the host server in step 520.

Once the file is written, the agent transport restarts. Upon restart each sensor is configured to monitoring. During the monitoring cycle on a host server, each sensor's frequency of monitoring is set by a tuning string that defines the monitoring intervals for a given hour or time period. Upon configuration of one or more sensors, the agent transport's sensors commence the monitoring and system information gathering. Any results from the sensors are stored in the host server's non-volatile memory in step 522. As steps 504-522 are in progress, the master transport polls other agent transports located on other host servers within the network for results. This polling is continuously done to gather information from each agent transport and store the results in the central server's database. Eventually, the master transport polls the newly configured agent transport, wherein the master transport requests the agent transport's results in step 524. The agent transport is intelligent enough to only queue results for transport to the master transport relating to a system change that has been detected. This reduces network traffic as well as minimize CPU load on the system running the agent transport, which allows the agent transport to put very little burden on the host system and network. The agent transport reads and aggregates the stored files from the sensor results located on the host server's memory in step 526. The agent transport compiles and packages the files into a single data package for transport to the master transport in step 528. Once prepared, the agent transport encrypts the single data package and transports it to the master transport at the central server in step 530. The master transport decrypts the package, and reads the packaged data, and separates each data file, writing it to the central server's non-volatile memory in step 532.

Once the master transport writes the separated data to its database, the master transport in step 534 retrieves the md5sum for each received data file, written to the central server's disk. As a verification step, the master transport, in step 536, posts the md5sum list with the corresponding file names, back to the agent transport.

The present invention relies on many external files during the course of its execution. Many of these files are static, and should never change. To ensure that these files have not been tampered with, the present invention checks the md5sum of the file, and verifies it against a known fingerprint, md5sum for example for that file that was built at compile time for the present invention. If the md5sum matches the known value, the present invention will continue execution using the file as needed. Once the present invention is finished with this particular thread of execution, it will no longer trust the file, and the next time this thread of execution is necessary, the present invention will check the file again. If the md5sum does not match, the central server will log the instance, and shut down, refusing to run again until the file in question is replaced with the original. Checksum checking happens on both the master transport, by the specified eval program engine and the agent transport.

Once the agent transport receives the md5sum with the file names from the master transport, the agent transport checks the md5sum and verifies that no data corruption occurred in transport to and decompiling of the results on the master transport side. The agent transport verifies the name of each data file on its disk and once the verification step is complete and a successful transport is made and verified, the matched files are removed from the host server's memory in step 538. The evaluation interface on the master transport, checks for the name of each date file on the disk received from the agent transport in step 540. Based on the root file name of each data file, the evaluation interface calls the appropriate eval, passing the data file name on the central server's non-volatile memory in step 542. Finally, if the eval runs without error, the master transport removes the data file from its non-volatile memory on the central server.

In the present invention the master transport processes and archives the results in a database located on the central server. The database contains all results transported by each agent transport's sensors. Each result is time stamped within the database. The time stamp allows administrators, auditors or forensic teams, using the user interface to reconstruct the historical configuration of a component being monitored. Reports can be custom formatted by the administrator to retrieve the results in user friendly formats for analysis. Alerts may be set to also generate a notice to the administrator or some other chosen person based on the conditions configured by the administrator or his representative.

The agent transport also generates, through the sensors, error and connection logs to assist with troubleshooting. The senors run continuously at defined intervals the intervals determinable by the administrator. In an exemplary embodiment, the sensors only generate a result when a change has been detected. If a change has occurred then the entire configuration for that particular application is retrieved and prepared for transport to the master transport.

FIG. 6 is a flow chart showing the method by which the transport receives the initial sensor information and the method by which the transport interacts with that sensor. In FIG. 6, Step 602, a sensor block is transported by the master transport to the agent transport. Upon receiving the sensor block, the agent transport writes the sensor block to nonvolatile memory on the host server. This block contains all of the sensor code and configuration data for each sensor. In the next, Step 606, the agent transport stop all currently running threads. Next, the agent executes an internal restart in Step 608. In Step 610 the agent transport reads in the new sensor block from the memory on its host server. Once the agent transport has read the new sensor block, in Step 612, the agent transport parses the sensor block, reading in one sensor in its configuration data at a time.

After reading in the sensor in Step 612, the agent transport checks to see if there are remaining sensors to be parsed in Step 614. If there is not, the parsing routine in the agent transport sleeps indefinitely. Upon parsing the sensor block in Step 612, the agent transport verifies that the sensor is an authorized sensor by checking for the sensor signature in Step 616. If the signature does not match, the agent parses a new sensor block. If the signature matches, the agent forks off a child, in Step 618, passing the sensor and its configuration data to that child. The agent transport, then moves on to the next sensor. After Step 618, the agent transport executes the sensor in Step 620. The sensor executes its program and the agent transport checks as to whether the sensor retrieves any result in Step 622. If no result is returned, the agent transport waits a set period of time and reexecutes the sensor in Step 620. If data is returned by the sensor, the agent transport encrypts the result and writes the data to the disc on the host sensor in Step 624 for further treatment by the agent transport.

When a result is returned, the sensor first writes the result to a file. For example, in an exemplary embodiment, if the password sensor runs, it will return two variables, one labeled fname_root, the other is the actual result. Another process writes a file labeled time_$fname_root.out where time would be the time in seconds, and $fname_root would be replaced with the value returned by the sensor for example (974530468_passwd_sns.out). If the sensor returns NODATA, the process simply goes into a wait state for the remainder of the set time, and runs the timer check again after this minute. The process ID will only check once per minute, to avoid running a sensor multiple times in the same minute.

Upon configuration the default has the sensors run a set period. For sensors that require additional CPU time the frequency can be adjusted as needed. One additional security feature is the ability to have the sensors run at random times. This would give, for example, the Operating System Integrity sensor the ability to run randomly between 1 and 5 minute intervals. This would keep an individual with malicious intent from knowing exactly when to plant a malicious program and thus makes it more difficult to bypass the capabilities of the present invention.

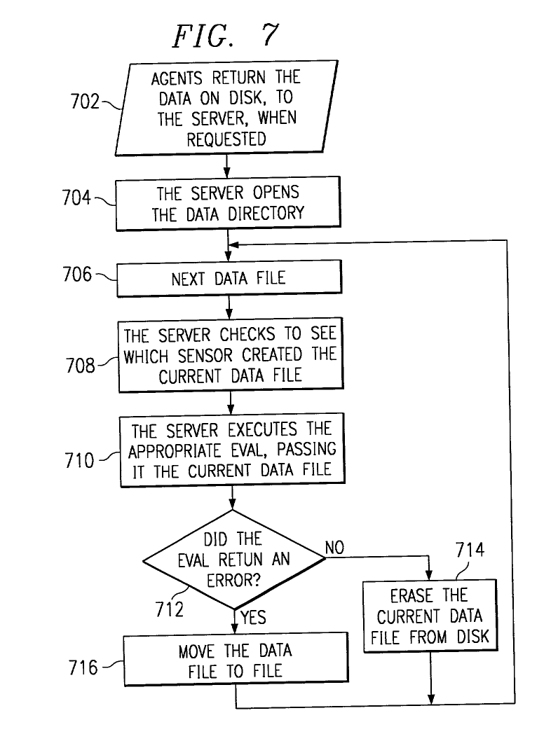

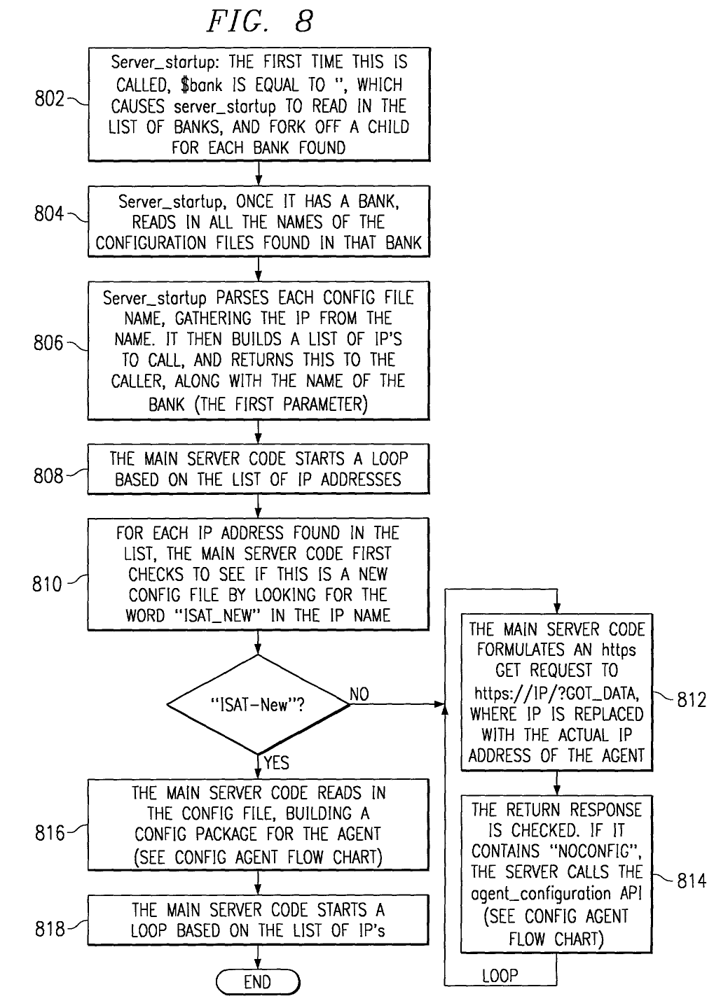

FIG. 7 is a flow chart that displays the methodology for the master transport to execute the eval programs in the central server. In FIG. 7, upon the agent transports results from the sensors to the master transport after a request from the master transport in Step 702, the master transport opens the result directory in Step 704 to gather information regarding the sensors that supplied the data. Upon opening result directory, the master transport checks to see which sensor created the current data file in Step 708. The master transport then executes the appropriate Eval program, passing it to the current result file in Step 710. If the Eval returns an error from the result in Step 712, then the Eval program moves the result to /opt/isatd/debug in Step 716. Then the master transport checks the next result file in Step 706. If the Eval does not return an error in Step 712, then the master transport erases the current result file from the nonvolatile memory on the central server. In this way, the central server maximizes its nonvolatile memory.

FIG. 8 is a flow chart displaying the methodology that the master transport requests data from the agent transport. In Step 802, upon receiving a server startup for the first time, a variable in the program is set to equal ‘’ which causes the server_startup to read in the list of banks, and fork off a child for each bank found. Once the server_startup has a bank, it reads in all the names of the configuration files found in that bank in Step 804. Next, in Step 806, the server_startup parses each configuration file name, gathering the internet protocol (“IP”) addresses from the name. It then builds a list of IP addresses to call, and returns this to the agent transport, along with the name of the bank. In Step 808, the master transport begins a loop based on the list of IP addresses. For each IP address found in the list, in Step 810, the master transport first checks to see if this is a new configuration file by looking for the word “ISAT_NEW” in the IP name. If it is not a new configuration file, the master transport formulates a “https://IP/?Got_Data”, where IP is replaced with the actual IP address if the address is an agent transport. In the next Step 814, the return respond is checked. If it contains “NOCONFIG” the server calls the agent_configuration API to begin configuring the agent. If ISAT_NEW is returned in Step 810, then in Step 816, the master transport reads in the configuration file, building a configuration package for the agent. The configuration package is then sent to the agent in accordance with the configuration agent flow chart. In the next Step 818, the master transport begins a loop based on the list of IP addresses.

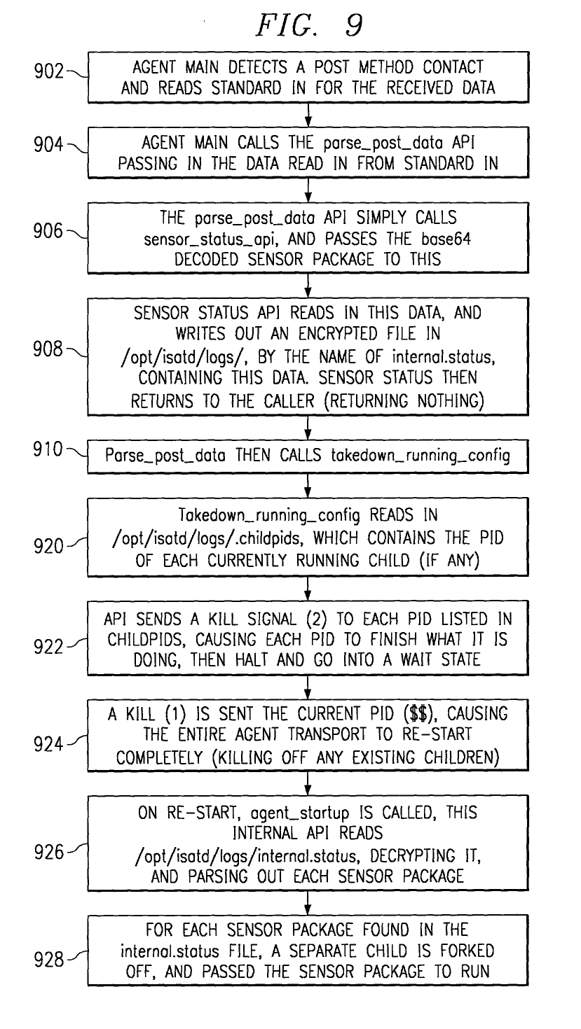

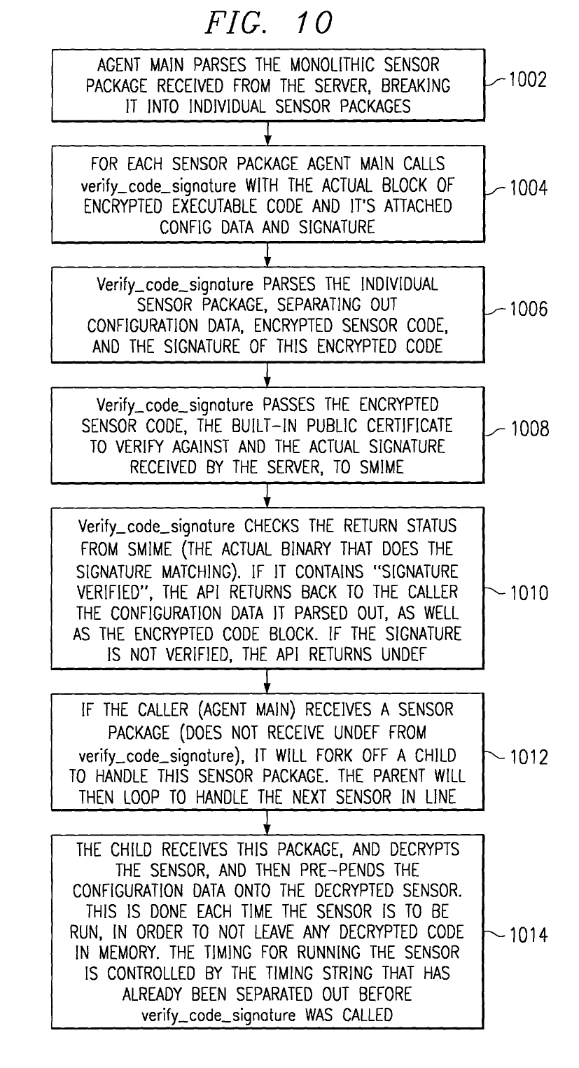

FIG. 9 is a flow chart that displays the methodology for the configuring the agent transport. When an agent transport detects a post from the master transport in Step 902, the agent transport reads standard in for the received data. Next in Step 904 the agent transport calls the parse_post_data API, passing in the data read in from standard. In Step 906, the parse_post_data API simply calls the sensor_status_api, and passes the base 64 decoded sensor package to the API, with the name “internal”. Next in Step 908, the sensor status API reads in the data and writes out an encrypted file in /opt/isatd/logs/, by the name of “internal.status”, containing the data. The sensor status then returns no message to the master transport. In the next Step, 910, the parse_post_data then calls takedown_running_config command to read in the /opt/isatd/logs/childpids, which contains the PID of each currently running child, if any, in Step 920. This API sends a kill signal (2) to each PID listed in the childpids. This causes each PID to finish executing its current command, then halt and go into a wait state in Step 922. Next, in Step 924, a kill (1) is sent to the current PID, causing the entire agent transport to re-start completely, killing off any existing children. Upon re-start, in Step 926, the agent_startup is called. This internal API reads /opt/isatd/logs/internal.status, decrypting it, and parsing out each sensor package. Finally, for each sensor package found in the internal.status file, a separate child is forked off, and passed to the sensor package to run in Step 928.

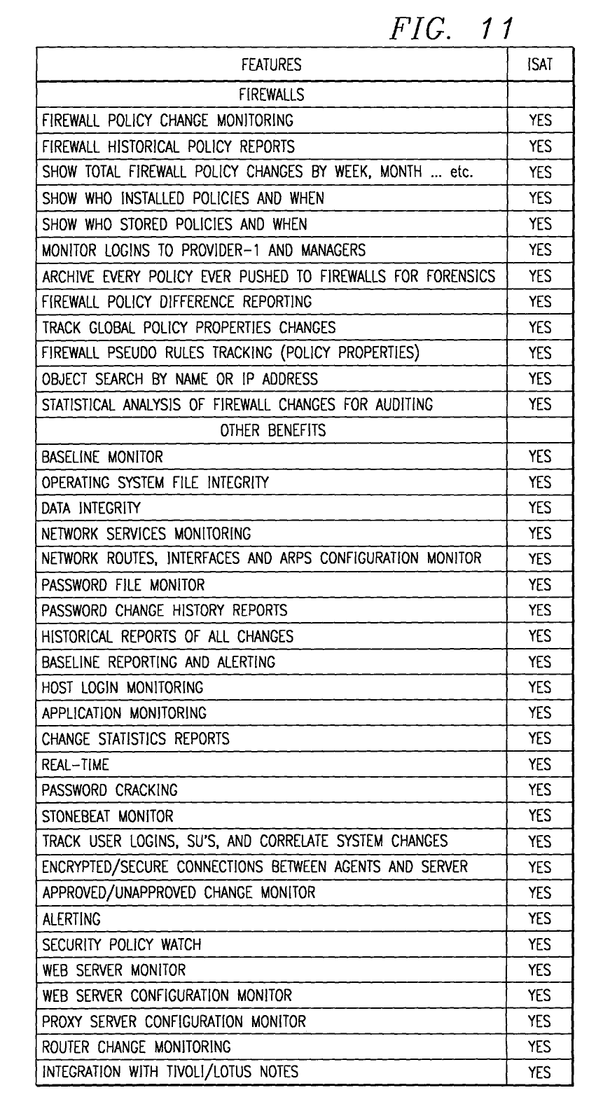

FIG. 10 is a flow chart which displays the methodology for code signature verification. When an agent transport parses the monolithic sensor package received from the master transport, it breaks it into individual sensor packages in Step 1002 as described previously. For each sensor package, the agent transport calls verify_code_signature with the actual block of encrypted executable code and its attached configuration data and signature in Step 1004. The verify_code_signature, parses the individual sensor package, separating out its configuration data, encrypted sensor code, and the signature of the encrypted code in Step 1006. Next, in Step 1008, the verify_code_signature passes the encrypted sensor code, which contains the built-in public certificate, to compare it against the actual signature received by the master transport and verify that the new sensor code information comes from an authorized source. In Step 1010, the verify_code_signature checks the return status from smime (the actual binary code that does the signature matching). If it contains “Signature verified”, the API returns back to the master transport, the configuration data it parsed out, as well as the encrypted code block. If the signature is not verified, the API returns UNDEF. If the agent transport receives a sensor package that is verified, it forks off a child to handle and execute this sensor package. The parent will then loop to handle the next sensor in line in Step 1012. Finally, the child receives its sensor package, decrypts the sensor, and then appends the configuration data onto the decrypted sensor. This is done each time the sensor is to be run, in order not to leave any decrypted code in memory. The timing for running the sensor is controlled by the timing string that has already been separated prior to the point when verify_code_signature was called in Step 1014.

### Auditing functions of system components.

Audits are conducted to ensure the compliance of various security policies. In the present invention, every organization is able to define guidelines and procedures that will makeup the organization's an overall security policy. Audits normally check system configuration weaknesses, weak passwords, whether guidelines and procedures are followed, and whether reasonable precautions have been taken to ensure data integrity. To ensure these policies are being followed, audits are performed on a regular basis. To successfully pass an audit, organizations set system baselines.

Baselines help to standardize the installation and configuration of all platforms in an enterprise. In the present invention, the agent transport captures host configurations and transports them to the central server for archiving. Configurations are only captured when changes occur and at initial install of the application. Storing configurations of every monitored host at the server allows users and auditors to generate reports, which can show current configurations, past configurations or even a history of configuration changes by time intervals for example, by day, week, month or even year.

Baselines are an important part of the information systems business process. Companies establish baselines to maintain standards across all hosts. Baselines are established for operating systems installed on hosts, applications installed on hosts, or the hardware that comprises the host itself; however, prior to the present invention, there was no adequate method of monitoring the established baselines. The present invention solves the problems in this area. The master transport directly monitors baselines for any of the areas requested by the administrator. An administrator can configure parameters, which define the baseline standard at the master transport which then pushes the configuration to all agents. The defined parameters are then compared against the data gathered by the agents from each host, and if any differences are found, it is then reported to the master transport as a violation of baseline. For example, if a software package installed on a host does not meet the current baselines, an alert then is generated.

For example, in Sun Solaris® the command “pkginfo” will list all software packages currently installed on the system. A sensor module can monitor the list and alert when any package is added or deleted on the monitored host. It can also monitor each directory on a host and alert if any program file is added or deleted from that directory. The sensor can also monitor the operating system version and patch release number. All operating system binaries are also monitored in case someone decides to add or delete any single file. These features are configurable and can be fine tuned by the administrator to monitor any aspect of the operating system.

The present invention implements the baseline technology with a template that is built as the reference specification. The master transport generates the baseline from the system. The template can contain information about file systems, files and their checksums, software packages installed, hardware that is installed, routes, arps, OS parameters, logging parameters, configuration files parameters, etc. The template is then compared to the results found on the monitored machines. If a system fails the comparison against the template then an alert is sent to the administrator.

As part of the baseline checking, the present invention offers a method, by paid subscription, whereby customers can download baseline templates or alerts. These templates will contain md5summ information for known applications, such as Sun Solaris 2.7. This allows a customer who wants to implement baseline alerting for their applications, to use the pre-maid template. One of the most powerful feature of this subscription service is automatic notification of software that has been reported to have a security hole. For example, a customer who monitors the files for Sun Solaris 2.7, might receive a security alert for part of the Solaris package. With the subscription service, the present invention can place an alert in the template noting the problem. When the baseline engine is run, it notes the alert in the template and verifies the version, and if it finds the particular version of the file that had the problem, then an alert is sent to the administrator notifying them of the problem.

Currently, to verify if an entire environment is up to date with the most bug-free software available, an admin has to log in to every machine and manually verify that each is using the correct version. The present invention automates the verification down to alerting the administrator.

Currently, companies spend a great deal of time gathering system configurations for audits. The present invention generates reports that will give this information at a significantly reduced cost to the organization. Because the amount of changes may be too many to independently verify each, one on a cost effective basis, the present invention allows auditors to generate statistical samplings of the changes for the auditor to compare against baselines or other criteria. Additionally, the present invention allows auditors to generate reports that shows average number of changes or total changes made to hosts. The present invention can monitor several types of applications and configurations on hosts. An example of applications and the sensors monitoring those configurations in an embodiment of the invention follows below.

Every application that exists can be monitored for configuration changes. The present invention monitors for configuration changes on as many multiple servers as exists in the distributive network. FIG. 11 is a table that shows the various components that the present invention monitors as a one step solution using the methodology described herein above. Because of the structure of the present invention, it is able to monitor and report on multiple firewall baselines and provide a wide variety of information, depending on the administrator's needs. The present inventions simultaneous multiple monitoring, auditing and reporting functions is more fully set forth in FIG. 11. It is to be understood that because of the modular approach of the present invention that FIG. 11 is a non-exclusive list, and any additional program or system can be added by having the appropriate sensor and eval code created and installed for the program as described above. The following sensors, along with their corresponding eval programs are provided, non-exclusively in the present invention for monitoring the appropriate systems within the network.

Firewalls—A firewall is software that is responsible for allowing selected network traffic into a private network. Security policies or rules define what traffic is allowed through or denied on that firewall. Firewall rules can be customized for a company's needs and rules can be added, deleted, or modified. Typically, these changes are saved to the Firewall configuration files and the old file is deleted. The Firewall Sensor monitors for these changes. Any change made to firewall policy is immediately captured by the sensor. This way all modifications can be tracked and logged. The administrator can later query the invention's database on the central server to find how a firewall policy was modified. The present invention records in the central server database what change occurred, at what time the changes occurred, and who made the change. Thus, anyone making a change that may compromise security creates an audit trail. The present invention's administrator's interface can use color codes to differentiate between policy additives, deletions and modifications. The present invention can monitor any of the currently popular firewall products that exists today or that may exist in the future by simply programming a specific sensor to account for the product. Once the sensor is established, the administrator uses the invention to transport the sensor to the proper agent transport whereby the sensor is actuated and executed.

Additionally the Firewall Sensor can capture the policy configuration files from the firewall manager or the firewall itself. The advantage of capturing the policy information directly from the firewall is that in the event that the firewall is compromised and a policy is modified directly on the firewall or pushed from a rogue manager, the agent still detects and records those changes.

Operating System Integrity Sensor (OSI)—The OSI Sensor monitors all critical system binaries of any operating system. The OSI Sensor computes a checksum on every file being monitored and runs at given intervals. The computed checksums are compared against known checksums to validate the files integrity. Any file that is modified is noted and transported to the master transport for archival and reporting purposes. This sensor ensures critical parts of the operating system are not tampered with or that Trojan horse programs are not introduced. Note: A Trojan horse is a malicious program installed by a hacker which may be used to gain access to a system or it may cause data loss/corruption at a predetermined time. Checksums are computed mathematical integers used to verify the integrity of a file.

Router Sensor—The Router Sensor interrogates a router and gathers the configuration data. The data gathered includes without limited the interface and route configuration as well as the hardware and software revisions. The router eval will store this data on the central server through the master transport and the reporting interface allows administrators the ability to search for changes that occurred across the routers in the enterprise.

The Router Sensor can be configured to monitor a log server that the router communicates with. This way the interrogations only occur when a change is noted, in large environments using a round-robin monitoring scheme would take too long and generate too much traffic.

Password Sensor—This sensor monitors the password files on systems and tracks any changes. It also captures the encrypted passwords. All of this information is sent to the master server. The master transport compares results and reports any changes. The master transport also attempts to crack passwords and report any passwords that were successfully deciphered.

Network Sensor—The Network Sensor monitors the complete information on network interfaces, such as a routing table, the ARP table (an ARP table is used to map a systems hardware address to it's IP address), and the communication ports open for communication on the system. The Network Sensor gives a complete snapshot of the network configuration of a system at any point in time.

IDS Sensor—The Internet Detection Systems (“IDS”) Sensor reports on the current policy configured on an IDS intrusion detection software, such as Internet Security Systems. This sensor can detect changes made to that policy and report what the change was.

WWW (Web server) Sensor—This Sensor reports on any configuration changes made to web servers such as Netscape Web Server®, Apache Web Server, Inktomi Web Server®, Microsoft® Internet Information Server or any other web server software which exists. This Sensor also monitors all files in the web server directory. These files may include graphic image files, cgi scripts, java or any other script in the cgi-bin directory, HTML (Hypertext markup language) files and etc. This Sensor also captures critical web server logs.

This Sensor can be used to monitor the entire directory structure of a web server. The directory of a web server contains all website content such as graphics, text files, executable scripts and programs and any other mechanism, which provides functionality to the web server being monitored. The parameters being monitored may include such files as file permissions, file contents, file size, file creation times and file ownership. In many large e-commerce environments multiple web servers or web farms may be used to facilitate high traffic. In such an environment, the present invention has the capability to monitor multiple web servers belonging to a web farm and report any inconsistencies found. All web servers in a cluster have similar configurations and content. If a change is detected on any server then it is compared against the other servers in the cluster. This way an entire server farm can be monitored for intrusions.

The Sensor may also monitors all logs on the web servers in a cluster and detects an unusual increase in the errors in the log, unusual traffic patterns, increase in traffic from a single source or any other unusual activity in the log files. This serves as any early warning system for possible “Denial of Service Attacks.” Unusual activity on one server, if detected early can reveal impending attacks.

The number of requests are also counted and compared against other servers in the cluster. This also serves as a web server utilization monitor showing activity in real-time. The web server monitoring feature can be customized to work with any commercially available web server software such as Netscape, Microsoft Internet Information Server, Sun Microsystems iPlanet, Apache web server, NCSA web server and Inktomi web server.

Proxy Sensor—This Sensor captures configuration changes made to proxy server configuration files. Some common proxy applications include Plug-gw gateway, Netscape Proxy server, Apache and other proxy servers that exist in the market.

Log Sensor—This Sensor captures messages posted to log files. This Sensor can monitor a single and multiple log files at a time. Some examples of logs includes “/var/adm/messages” on most popular operating systems. This Sensor can monitor logs generated by any application, and gathers logs from firewalls, web servers, proxy servers, UNIX, Microsoft NT or Windows 2000 servers or any other platform and application which generates error logs, access logs and other logs. These logs will be archived by the master transport at the central server where the data from all logs will be used to help security forensics experts by being in one central repository. A central repository reduces the amount of time required to research an incident. System administrators can view logs generated by systems across the enterprise. These logs can be compared with other logs to create a clearer picture of the sequence of events leading to a compromise.

Login Sensor—This Sensor captures all login attempts for example, File Transfer Protocol and Telnet. All login attempts are stored in detail, giving such information as the user's IP (Internet Protocol) address, the date and time, and even the commands that are issued during the session. This capability can be configured to give the administrator the option to view commands an intruder is issuing on a system in real time. Security staff can use this to monitor logins and watch what an authorized user is doing on the monitored system. This Sensor can be switched off in environments where security requirements are not as stringent.

This Sensor monitors all system login attempts by authorized and unauthorized users. Sensors record the time a user logged into a system, the date, the userid, and from which host the login originated. The data can be correlated to show the change that occurred on the system and the login id under which the change occurred. Because the invention constantly monitors a system, the software is able to create an extensive audit trail. An audit trail is essentially a detailed log of events in a timely sequence.

DNS/Sendmail sensor—This Sensor monitors configuration changes made to mail configuration files (Sendmail.cf for Sendmail) and DNS (Domain Name System) configuration files.

Database sensor—This sensor monitors any changes made to a database configuration including user additions and deletions including permission changes, table definition modifications, and performance tuning changes.

Other sensors can also be developed to monitor a multitude of applications and types of systems that exist. Sensors can be developed to monitor configuration changes of any application used in the industry. Multiple sensors may monitor a system because each sensor monitors a different aspect. For example the Firewall sensor, the Password Sensor and the Operating System Integrity sensor may monitor a firewall server. Several different sensors monitoring a single system help to create a more complete picture of the configuration. Today's complex information systems are composed of many parts, each part having its own unique configuration, which can be monitored by the present invention's sensors. This approach provides information security forensic experts a clearer picture of what has changed on the system caused a security incident. The present invention helps reduce careless configuration errors by alerting security staff of all changes that occur on a system and applications running on that system.

The forensics and audit trail features provide security forensics experts the capability to analyze data after an abnormal incident has occurred on their system to assist them with finding the cause.

The administration interface is a key component of the master transport. The administrator or other authorized users can view the interface using any web browser. Users can generate and view custom reports. The custom reports are created based upon any parameter stored within the database, for example, time, date or host specific including combinations of multiple parameters. Users can query the database using the interface to get specific information needed and the report generated are application specific and mirror the application being monitored.

For example, the Firewall change report displays the ruleset as it appears within Firewall software, including the same color scheme, icons and other features of the Firewall software. This design approach provides the user with a more intuitive report. Users can additionally use the date or time query to view the configuration of any system as it appears at that point in time.

The user interface has extensive report calling capability. With the extensive amount of data stored in the database, it is important to mine that data and generate useful reports for management and other interested audience. Reports can be divided by baseline, compliance, forensics, or any other systemology determined by the administrator.

### Alerting and Additional Features

The present invention provides an alerting feature. The present invention allows the alerting function to be configured by the administrator through a graphical user interface (“GUI”), which allows the administrator to specify alerting conditions.

Typically, in an exemplary embodiment, alerts can be issued when a certain change takes place on a monitored system. For example, if the system administrator configures the Password Sensor to report that userid “John Doe” was created on system “xyz,” and the administrator configures an alert to be issued if that userid is created, then the master transport sends an alert via email, pager or any other device or method upon the sensor detecting the creation of the userid. This alert feature also can be applied to the Firewall Sensor or any other sensor. The administrator can configure an alert to send alarms when a rule is added or deleted or modified.

The present invention's alerting function provides a security policy watch. An organization can configure alerts that adhere to existing corporate security policies and standards. If these policies are violated then alerts are issued to safeguard against those infractions. The present invention also ensures standards are enforced across the enterprise, insuring external or internal audits are followed and provide supportable evidence of compliance. The present invention allows an organization to custom configure policy and audit watches in accordance with that organization's written information security policies.

Another feature of the present invention is the search module. System administrators can search to find a particular piece of information. For example it can be used to find if a particular userid exists on a particular host, to find which firewall is using a particular IP address, or to find the name of the Checkpoint policy object with the corresponding IP address. The search tool gives administrators enormous capability to find configuration information that may exist on one out of hundreds of systems monitored by the present invention across the enterprise. Due to the enormous amount of data collected by the present invention, a tremendous amount of information can be reported upon using the centralized database on the central server as a central repository that maintains up to date statistics.

Another key feature of the present invention is the ability to give system configuration change information to an administrator. Organizations can view changes that have been made to the configuration of a system. The administrator can see how his firewall policy has been modified, for example, which rules were deleted, and which rules were added. This applies to the configuration of any application being monitored by the master transport such as web server software, proxy software, password files and so on. The master transport has an internal logging capability, which can be used to troubleshoot problems that can arise. For example an agent transport may loose contact with the master transport caused by network connectivity failure or shutdown of the agent transport process on a monitored system. If there are any interruptions in communication then they are logged for later forensics.

Another feature of the present invention is that it monitors approved and/or unapproved changes made to systems. This is known as the Change Control Module. In the enterprise, information systems are constantly undergoing maintenance or system administration. Anytime a change is scheduled it is recorded in or logged on the central server by the administrator who will be making the change. The user enters in English text the changes that will be made, which systems the change will be made to and when the change will occur. Once this information is entered it is stored in the database. When the change occurs, the agent transports monitoring the system will detect the changes that were made and transport it to the master transport where it is evaluated and stored on the central database. This allows auditors or management to review the change control that was entered and compare against the actual change that was made. Thus, the present invention yields auditable changes whether they are honest errors made during maintenance or malicious intentions by internal staff.

Critical business systems should be monitored in every way especially when changes are made to them on a regular basis. Authorized users are the single greatest source of information system security breaches.

### Software source code security

The present invention also prevents “copy cats” from viewing source code. All source code of the software in the present invention is encrypted. Anyone trying to reverse engineer this security tool will find it very difficult. This feature is unique and it helps to protect the technology as well as protect customers from malicious users who may try to undermine the monitoring capabilities of this security tool.

In an exemplary embodiment, when “isatd” (the present invention's program executable) starts, it first checks a signature, usually a digital signature, the system loader, the encryption modules, Agent.pm, and Server.pm. These are all critical components of the present invention's security tool. If all md5sums match, then it completes normal startup sequence. If md5sums don't match, the master transport shuts down the central server, and tells the operator to re-install system files. Once isatd starts, and receives a request for the agent side, the Agent.pm calls a special routine. This program checks the md5sum of its caller. If it matches the known md5sum, it returns a key, if not, then “Isatd, Copyright 2000 SIDR Labs” message is returned. The key that gets passed back from the master transport, is then used to decrypt the source code, and this is then run in an eval block. The basic function of the system is that any curious user that attempts to modify either Agent.pm or Server.pm to get the key to print, will be stopped by the md5sum checker of isatd. Even if the user tries to run Agent.pm from their own perl environment, the caller md5sum won't match, and system will just print out the copyright notice.

The encryption scheme also protects organizations from malicious persons attempting to introduce rogue programs using our sensor/eval structure.

### Application Programming Interface

The present invention provides easy adaptability, providing the necessary features of a changing business environment. The Application Programming Interface (API) serves as a mechanism by which developers can easily customize the master transport for the monitoring of a range of e-commerce applications and operating systems. The APIs are functions that send and receive data in a standard format. Parameters in the APIs provide for modification of the present invention's functionality. Developers may use the APIs to easily add features to the present invention. The present invention's APIs can be classified into two classes: the agent side APIs and the master side APIs. The agent APIs are specific to the agent. They give developers the flexibility needed to quickly integrate new features using a common defined Application Programming Interface. The master APIs serves the same purpose on the central server side. Extensibility is a key design consideration of present invention and the APIs exist for that reason.

### Agent Application Programming Interface

There are several defined APIs for the agent. In the section that follows these APIs will be discussed in more detail.

### Globally defined variables used in the API are as follows

The Interrupt Signal Handler sets the global variable “stop_bit” to 2, and when this is checked in agent_sleeper and handled by agent_shutdown, all children threads will stop and go into a catatonic state until they are killed by the parent thread. Note the same for SIG{KILL}, SIG{TERM}, and SIG{HUP}

$SIG{KILL}=sub{$stop_bit=9;};

$SIG{TERM}=sub{$stop_bit=15;};

$SIG{HUP}=sub{$stop_bit=1;};

### The Agent—sleeper API

The Agent sleeper API is an internal API used to control the rate at which the agent side of the transport tries to run sensors. After each internal action, this API is called. It simply sleeps for a set amount of time, preventing the ‘throttling’ of the Agent. Throttling would occur if the agent didn't wait until after each cycle, then it would try to run a sensor as many times as possible during a matching time cycle, causing high cpu utilization on the monitored host. This API takes no arguments. When called, it first checks stob_bit, and if it is set, it calls agent_shutdown to shut the agent down. The agent_sleeper will sleep for 60 seconds, but before doing so, it will check to see if the global variable $stop_bit has been set. If so, it will call agent_shutdown, and this API will shut the agent down.

### The verify_code_signature API

The present invention utilizes a code signature mechanism to verify that sensor and eval code that will be executed in the transport layer, is truly from the intended provider, and is not malicious. In order to accomplish this, the present invention calls an external binary called SMIME. SMIME is a third party application that can take a public key, and verify the SMIME signature of a document as coming from the paired private key. In order to verify that the SMIME binary is not a Trojan Horse, verify_code_signature API first checks the md5sum of the SMIME binary. This md5sum is verified against a compiled and known md5sum that was set at build time for the present invention's binary. If the md5sums match, the verify_code_signature API separates out the encrypted sensor from its signature, then calls the smime binary, passing it the sensor, the signature, and our built in public key to verify against.

If smime returns a verification of signature, verify_code_signature will then take the now trusted sensor/eval, and any accompanying configuration data and pass those back to the calling agent transport. It is then the responsibility of the calling agent transport to take this, decrypt the sensor/eval, and run this trusted code. The configuration data is trusted since it must come in the form of a variable (sensor_config). If any unencrypted data comes in any other form, the API will fail to verify the sensor signature, and will exit.

If smime does not return a verification of signature, it logs this event, and returns UNDEF to the caller. The caller will then fall through to a standby state, and will not continue. Any failure of a signature should be viewed with extreme concern, because it implies someone trying to push malicious modules to our transport layer. The argument passed to this API is the encrypted sensor/eval with any sensor config data pre-pended to the sensor. The API will automatically parse out the config data and the sensor/eval, and only verify the sensor/eval code.

### The decrypt_incoming_data API

The present invention stores encrypted status results to the central server database disk. At times, it needs to read the result back from the database. In order to simplify the decryption, and to take advantage of the setup already done for the encryption, decrypt_incoming_data has been written as a wrapper. This API takes the cipher text block, and passes back the decrypted text (plaintext block) to the caller.

### The encrypt_outgoing_data API

The present invention stores data on disk, in an encrypted format. It utilizes industry standard encryption and a standard key, such as a 4096 bit symmetrical key, to do this. The encrypt_outgoing_data is simply a wrapper API that allows the present invention to set up the encryption package once, and to encrypt data multiple times without the added setup overhead. The encryption is externally initialized on transport startup. Encrypt_{—outgoing_data takes only one argument, the data to be encrypted. It returns the cyphertext block to the caller.}

### The package_outgoing_data API

Due to the transport mechanism used by the present invention, this eliminates all carriage return in the data block, that is to be transported across the network. To accomplish this, the present invention uses base 64 mime encoding. Package_outgoing_data takes one argument, the block of data to be encoded, and returns back the base 64 mime encoded data to the caller. This way, data is packaged into a standard transportable format. Note that for mime encoding, carriage return are converted as shown. CTRL-A->“^{ΛA”}

### The timing_control() API

The timing control API is used internally by the agent transport. This API takes a single string as it's only argument, and returns either 1 or undef to the caller. A “1” is returned if the current time matches the timing string. “Undef” is returned if the current time does not match the timing string. What follows is an example of how this system works.

1) The string passed in to this API should take the following form

| | |
|---|---|
| Format -> ‘* * * * *’ | |
| Position -> 0 1 2 3 4 | |
| list of values | |
| 5 [0]=> min | 00-59 |
| 5 [1]=> hour | 00-23 |
| 5 [2]=> dayofmonth | 01-31 |
| 5 [3]=> mon | 01-12 |
| 5 [4]=> dayofweek | 00-06 (00 being Sunday) |

5 The argument is a string in the style of cron (numbers only)
5 Note that each position can contain a comma separated list of values

2) Examples

If a match is made every 10th minute on the 3rd day of the week of every month, and every week, you would specify:

‘00,10,20,30,40,50 * * * 2’The ‘*’ is interpreted as a wild card as in regular shell. ‘*’ always matches.

If a run is made every minute (The maximum resolution for the timing control API), then the administrator would specify ‘* * * * *’ Which matches every time the API is called

3) Example usage timing_control(‘10,20,30,40*** 2,3,4’);

This would return true on the 10th, 20th, 30th, and 40th minute of every hour, on the 3rd, 4th, and 5th day of every week of every month. (Tuesday, Wednesday, Thursday).

### The write_outgoing_data($$) API

The present invention relies on a standard for the file names that it gives to transportable files. This format is as such: ${date}_${root_file_name}.out. The root_file_name is the name of the sensor with “sns” appended. An example would be the password sensor: it's root file name is passwd_sns. The present invention uses this API to ensure that file names are consistent. This API takes two arguments:

1) root file name—This is the root name of the eval that will be called on the server side. For the passwd sensor, it's accompanying eval is called passwd_sns.eval. Hence, the root file name, passwd_sns. ‘passwd_sns’must then be the first argument when the password sensor wishes to write data to disk for transport

2) data—This is the data itself, that will be written to disk. No encryption or packaging is done in this API, it does not modify the raw data coming in, it only writes it to disk.

This API does not return any values, but it will log attempts to write empty files, silently failing to do so. This API will automatically write out all data files in /opt/isatd/data.

write_outgoing_data will place the timestamp on the file automatically, and it gets this date from the current time on the host machine. This date is written as seconds.

The following is claimed:

1. A method of monitoring a plurality of security parameters for a networked system having a first server and at least one second server, the networked system having a transport communication layer, the transport communication layer having a master transport located on the first server, the method comprising the steps of:
comparing a data set located within a resident program located on the at least one second server against a rule set generated by a user;
generating a result forwardable to the master transport based on the step of comparing;
collecting the results in the first server; and
reporting the results from the first server to the user.

2. The method of claim 1 wherein the first server concurrently performs other networking tasks during the steps of comparing, generating, collecting, or reporting.

3. The method of claim 1 wherein the step of comparing is performed by an agent transport located on the at least one second server.

4. The method of claim 3 wherein at least one second server concurrently performs other networking tasks during the steps of comparing, generating, collecting, or reporting.

5. The method of claim 3 further comprising:
providing a list of one or more sensor programs for comparing data sets in a task list resident in the agent transport.

6. The method of claim 5 further comprising:
accessing, by the agent transport, the task list; and
selecting a resident program to monitor.

7. The method of claim 3 further comprising
selectively accessing, by the transport agent, a sensor program on the second server.

8. The method of claim 7, the step of comparing performed at least in part by the sensor program.

9. The method of claim 8 further comprising:
reordering the task list.

10. The method of claim 8 wherein the sensor program is responsible for monitoring an as yet unmonitored program resident on the second server.

11. The method of claim 8 wherein the comparing by two or more sensor programs generates reportable results.

12. The method of claim 9, the step of reordering comprising adding a sensor program.

13. The method of claim 11 wherein the reportable results are combined into a single transportable packet.

14. The method of claim 13 wherein the agent transport encrypts the forwardable result.

15. The method of claim 14 wherein the master transport decrypts the forwardable result.

16. A method for monitoring a security parameter for a network, the network having a first and a second server, the first server having a transport mechanism communicatively connected to the second server, the method comprising the steps of:
monitoring at one or more times for changes to a firewall policy;
collecting on the first server the changes to the firewall policy;
storing the changes to the firewall policy on the first server; and
compiling a history of the changes to the firewall policy on the first server;
reporting the history of the firewall policy changes; and
the second server performing other networking tasks concurrently with the steps of collecting, storing, compiling, or reporting.

17. The method of step 16, further comprising the steps of:
monitoring whether a change is an approved change;
archiving changes into a first report, the report identifying approved changes.

18. The method of claim 17 further comprising the steps of:
monitoring information on an administrator of a networking policy change;
collecting information on the administrator of the networking policy changes;
archiving one or more sets of information on the administrator; and
compiling the one or more sets of information on the administrator of the networking policy changes, the user able to view the compiled information in a format determinable by the user.

19. The method of claim 18 further comprising the steps of:
monitoring the time of the administrator's networking policy changes;
collecting the time of the administrator's networking policy changes;
archiving one or more sets of times of the administrator's networking policy changes; and
compiling the one or more sets of time of the administrator's networking policy changes, the user able to view the compiled time in a format determinable by the user.

20. The method of claim 19 further comprising the steps of:
collecting the firewall policy change that is pushed to the firewall policy;
archiving one or more sets of firewall policy information that is pushed to the firewall policy; and
compiling the one or more sets of firewall policy information that is pushed to the firewall policy, the user able to view the compiled firewall policy information that is pushed in a format determinable by the user.

21. The method of claim 20 further comprising the step of:
establishing one or more baselines by an administrator for a system on the network;
monitoring the one or more baselines established by an administrator;
collecting information on changes to the one or more baselines into a baseline report;
archiving a one or more baseline reports of the changes; and
compiling the one or more baseline reports, the user able to view the compiled information in a format determinable by the user.

22. The method of claim 21 further comprising the step of:
monitoring one or more operating system's file integrity on the network;
collecting information on changes to the one or more operating system's file integrity into a file integrity report;
archiving the one or more file integrity reports; and
compiling the one or more file integrity reports, the user able to view the compiled information in a format determinable by the user.

23. The method of claim 22 further comprising the step of:
monitoring a Web server's configuration file;
collecting information on changes to the Web server's configuration file into a Web Server's configuration report;
archiving the one or more Web Server's configuration reports; and
compiling the one or more Web Server's configuration reports, the user able to view the compiled information in a format determinable by the user.

24. The method of claim 23 further comprising the step of:
monitoring a proxy server's configuration file;
collecting information on changes to the proxy server's configuration file into a proxy server's configuration file report;
archiving the one or more proxy server's configuration file reports; and
compiling the one or more proxy server's configuration file reports, the user able to view the compiled information in a format determinable by the user.

25. The method of claim 24 further comprising the step of:
monitoring a user's password strength;
collecting information on the password's strength into a password strength report;
archiving the one or more password strength report; and
compiling the one or more password strength report, the user able to view the compiled information in a format determinable by the user.

26. The method of claim 25 further comprising the step of:
establishing a one or more events that triggers an alert;
monitoring for the one or more alert triggering events;
providing an alert notice upon the occurrence of the one or more alert triggering event.

27. The method of claim 26 further comprising the steps of:
collecting information on the one or more alert triggering event into a alert report;
archiving the one or more alerts reports; and
compiling the one or more alert reports, the user able to view the compiled information in a format determinable by the user.

28. The method of step 27 further comprising the step of:
monitoring encrypted secure connections between the first and the one or more second servers.
